(19) United States
(12) Patent Application Publication
(10) Pub. No.: US 2011/0119915 A1
(43) Pub. Date: May 26, 2011

(54) METHOD AND DEVICE FOR MOUNTING CAM ANGLE SENSOR FOR INTERNAL COMBUSTION ENGINE

(75) Inventors: Wataru Sanbyakuda, Osaka (JP); Kunihiko Ohkubo, Osaka (JP); Hideyuki Kou, Osaka (JP); Eiichi Komatsu, Osaka (JP)

(73) Assignee: Toyota Jidosha Kabushiki Kaisha, TOYOTA-SHI (JP)

(21) Appl. No.: 13/000,474

(22) PCT Filed: Jun. 12, 2009
(86) PCT No.: PCT/JP09/60769

§ 371 Date: Feb. 11, 2011

(30) Foreign Application Priority Data
Jun. 23, 2008 (JP) 2008-162995

(51) Int. Cl. B23P 6/00; B23P 19/00

(52) U.S. Cl. 29/888.011; 29/700

(57) ABSTRACT

In an internal combustion engine in which a head cover 3 for covering a cam shaft 2 at an upper face of a cylinder head 1 is made of a synthetic resin, a cam angle sensor 10 for the cam shaft is securely attached to the cylinder head such that heat damage to the cam angle sensor is suppressed. The cam angle sensor 10 is inserted in a through-hole 12 perforated through the head cover, and a mounting portion 14 integral with the cam angle sensor is fastened to a member 6 of the cylinder head, with fixing members 15, 16 penetrating through the head cover on a side of the cam angle sensor.

### TECHNICAL FIELD

The present invention relates to a method and a device for mounting a cam angle sensor in an internal combustion engine.

### BACKGROUND ART

Generally, in an internal combustion engine in which the valve timing of an intake valve or an exhaust valve is variable, it is necessary to constantly detect, by using a cam aperture sensor, the cam angle of a cam shaft that opens or closes the intake valve or the exhaust valve.

Patent document 1, as prior art, proposes mounting a cam shaft angle sensor to a member of a cylinder head, rather than to a head cover for covering the upper face of the cylinder head.

Specifically, a mounting portion is formed integral with a member of the cylinder head, such as a bearing cap that pivotally supports the upper half of the cam shaft, in a manner such that the mounting portion penetrates through the head cover to project beyond the upper side of the head cover. The angle sensor is removably attached to the mounting portion by being fitted into a mounting hole made in the mounting portion and fastened with a bolt.

Patent document 1: JP-A-2006-220073

### DISCLOSURE OF THE INVENTION

### PROBLEM TO BE SOLVED BY THE INVENTION

In accordance with the conventional mounting structure, the angle sensor can be securely supported, without being affected by vibration or deformation occurring at the head cover.

However, the angle sensor, as stated above, is fitted and bolted in the mounting hole in the mounting portion, which is an integral part of the bearing cap. Thus, the heat generated on the part of the cylinder head is readily conducted to the angle sensor. Accordingly, the angle sensor can be unduly damaged by the heat from the cylinder head.

It is therefore a technical object of the present invention to provide a mounting method and device capable of overcoming the problem noted above.

### MEANS FOR SOLVING THE PROBLEM

To accomplish the technical object, as set forth in claim 1, a method according to the present invention comprises: inserting a cam angle sensor into a through-hole perforated through a head cover made of a synthetic resin for covering an upper face of a cylinder head, the cam angle sensor being provided for a cam shaft at the upper face of the cylinder head; and fastening a mounting portion integral with the cam angle sensor to a member of the cylinder head by using a fixing member penetrating through the head cover.

As set forth in claim 2, in the method according to claim 1 of the present invention, the fixing member fastens simultaneously, to the member of the cylinder head, both the mounting portion of the cam angle sensor and a portion of the head cover through which the fixing member penetrates.

As set forth in claim 3, in the method according to claim 1 or 2 of the present invention, a collar made of a metal is disposed at the portion of the head cover through which the fixing member penetrates in such a manner that the collar abuts the mounting portion of the cam angle sensor and the member of the cylinder head.

As set forth in claim 4, a device according to the present invention is configured such that, in an internal combustion engine in which a head cover for covering a cam shaft at an upper face of a cylinder head is made of a synthetic resin, the cam angle sensor for the cam shaft is inserted in a through-hole perforated in the head cover, and a mounting portion integral with the cam angle sensor is fastened to a member of the cylinder head by using a fixing member penetrating through the head cover.

As set forth in claim 5, in the device according to claim 4 of the present invention, the fixing member fastens simultaneously, to the member of the cylinder head, both the mounting portion of the cam angle sensor and a portion of the head cover through which the fixing member penetrates.

As set forth in claim 6, in the device according to claim 4 or 5 of the present invention, a collar made of a metal is disposed at the portion of the head cover through which the fixing member penetrates in such a manner that the collar abuts the mounting portion of the cam angle sensor and the member of the cylinder head.

### ADVANTAGES OF THE INVENTION

According to the arrangement set forth in claims 1 and 4, the cam angle sensor is securely fastened to the member of the cylinder head by using the fixing member penetrating through the head cover. On the other hand, with respect to the head cover, the cam angle sensor is merely inserted in the through-hole provided in the head cover made of a synthetic resin. This arrangement ensures that the cam angle sensor is securely mounted to the cylinder head while heat transmission from the cylinder head to the cam angle sensor is significantly suppressed as compared with the conventional structure in which the cam angle sensor is inserted in a mounting hole provided on the cylinder head side.

In this way, the cam angle sensor is effectively kept from suffering the heat damage originating from the cylinder head.

According to the arrangement set forth in claims 2 and 5, at the same time as mounting the cam angle sensor, the portion of the head cover close to the cam angle sensor is supported on the cylinder head in such a manner that vibration at this portion is suppressed.

According to the arrangement set forth in claims 3 and 6, the collar made of a metal reinforces the fastening of the cam angle sensor to the member of the cylinder head.

### BRIEF DESCRIPTION OF THE DRAWINGS

FIG. 1 is a vertical cross-sectional front view showing an embodiment of the present invention;

FIG. 2 is a sectional view taken along lines II-II in FIG. 1; and

FIG. 3 is an exploded view.

### REFERENCE SIGNS

1 cylinder head
2 cam shaft
3 head cover
5 bearing portion
6 bearing cap
8 rotor
10 cam angle sensor
11 boss
12 through-hole
14 mounting portion
15 collar
16 fastening bolt

### BEST MODE FOR CARRYING OUT THE INVENTION

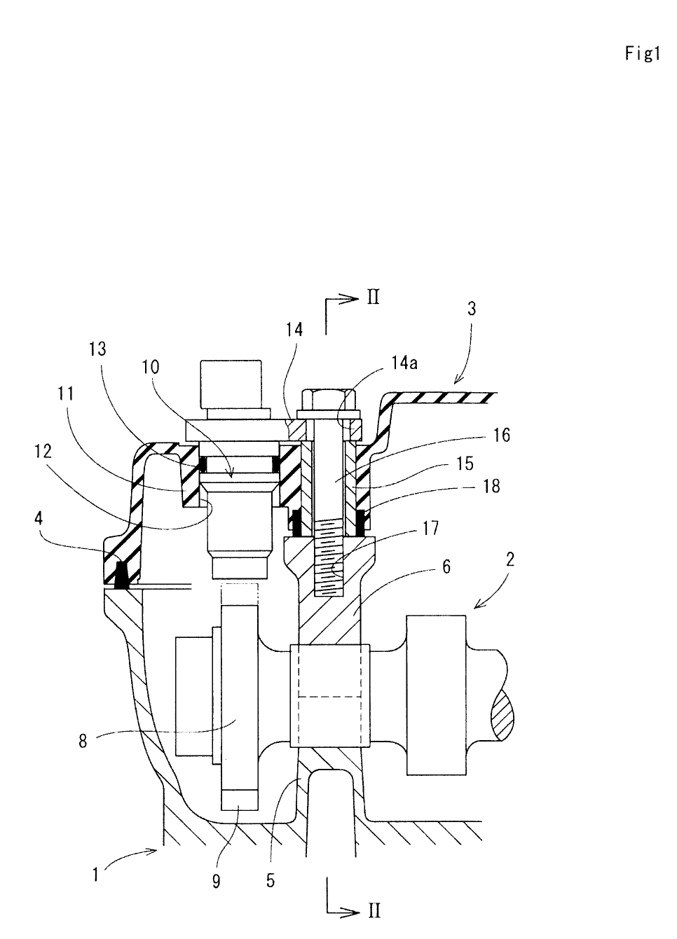

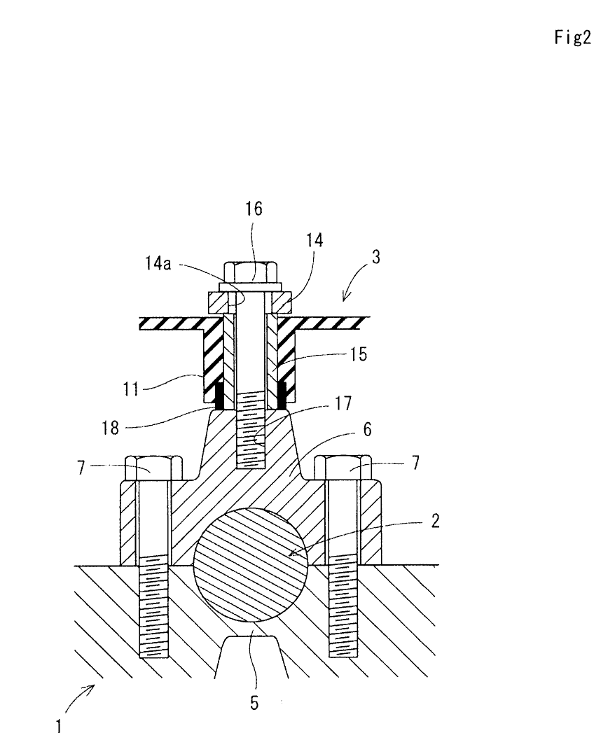

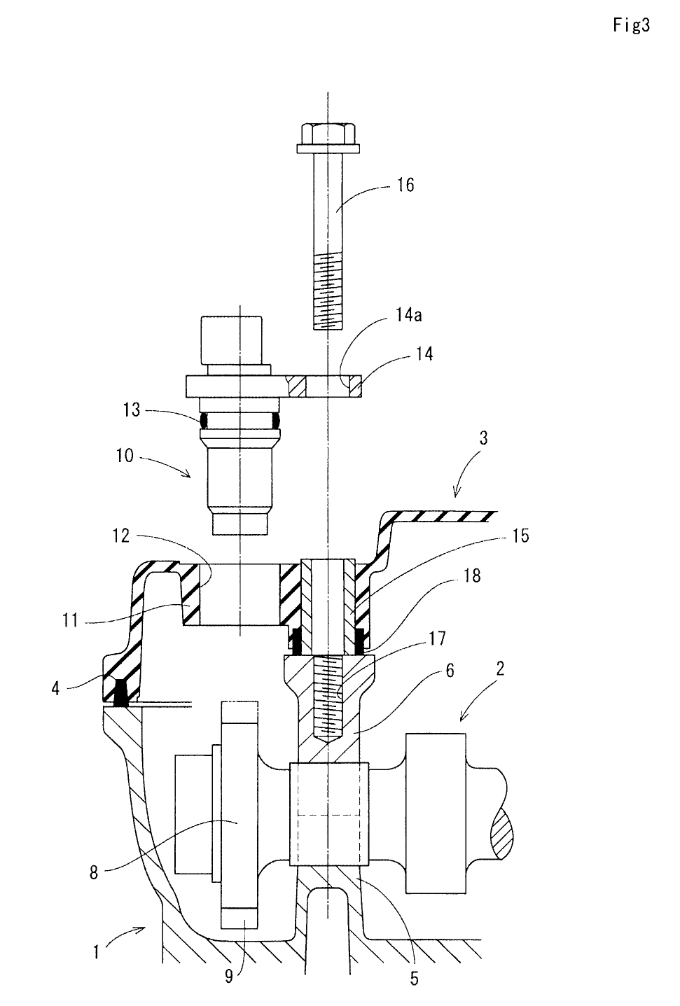

Embodiments of the present invention will be described below with reference to FIGS. 1 to 3.

In these figures, indicated by reference sign 1 is a cylinder head of an internal combustion engine. A head cover 3 made of a synthetic resin is disposed above the upper face of the cylinder head 1 so as to cover a cam shaft 2 pivotally supported on the upper face of the cylinder head. As conventionally known, the head cover 3 is removably attached to the cylinder head 1 by fastening bolts (not shown), which are disposed at and penetrate through the periphery of the head cover. With the bolts tightened, a seal member 4 disposed under the periphery of the head cover is compressed.

The cam shaft 2 on the upper face of the cylinder head 1 is rotatably supported by a bearing portion 5, formed integral with the cylinder head 1, and a bearing cap 6 which is fastened to the bearing portion 5 with a pair of bolts 7 for the right and left sides of the cap. The cam shaft 2 is provided with a rotor 8 adjacent to the bearing portion 5 and the bearing cap 6, where the rotor has projections 9 at phase positions where an intake valve or an exhaust valve is opened or closed.

Indicated by reference sign 10 is a cam angle sensor. The cam angle sensor 10 is inserted in a through-hole 12 in a boss 11 integrally formed in the synthetic resin head cover 3, such that an end of the cam angle sensor 10 can face the projections 9 of the rotor 8 of the cam shaft 2. The cam angle sensor 10 is provided with a seal ring 13 around the outer circumferential surface, so that the seal ring is held in close contact with the inner circumferential surface of the through-hole 12.

The cam angle sensor 10 is integrally provided with a mounting portion 14 at a position outside of the head cover 3.

In the boss 11 of the head cover 3, a collar 15 made of a metal is fixed so as to penetrate through the boss 11 at a position right above the bearing cap 6. The lower end of the collar 15 abuts the upper face of the bearing cap 6, while the upper end of the collar 15 abuts the lower face of the mounting portion 14 of the cam angle sensor 10.

A headed fastening bolt 16 is inserted in the collar 15 through a bolt hole 14a perforated in the mounting portion 14. The lower end of the fastening bolt 16 is screw-engaged with a female thread 17 formed in the bearing cap 6 of the cylinder head 1, so that the fastening bolt 16 is tightened. A seal member 18 having a ring shape surrounding the outer circumference of the collar 15 is provided between the lower face of the boss 11 of the head cover 3 and the upper face of the bearing cap 6.

In the above-described structure, the cam angle sensor can be securely mounted to the bearing cap 6 of the cylinder head 1, via the metal collar 15, by tightening the fastening bolt 16. Also, the boss 11 of the head cover 3 and further a portion close to the cam angle sensor 10 can be pressed against the bearing cap 6 of the cylinder head 1, so that these portions are properly supported with suppressed vibration.

In addition, the cam angle sensor 10 is simply inserted in the through-hole 12 of the head cover 3 made of a synthetic resin. Thus, heat transmission from the cylinder head 1 to the cam angle sensor 10 is effectively suppressed.

In the foregoing embodiment, the bearing cap 6 for pivotally supporting the upper half of the cam shaft 2 is used, among members of the cylinder head, for mounting the bearing cap 6. The present invention, however, is not limited to such a configuration. Another member formed integral with the cylinder head 1 (for example, the bearing portion 5) or a separate member attached to the cylinder head 1 may be adopted as “the member of the cylinder head” in the claims below for mounting the cam angle sensor 10.

1. A method of mounting a cam angle sensor in an internal combustion engine, the method comprising: inserting a cam angle sensor into a through-hole perforated through a head cover made of a synthetic resin for covering an upper face of a cylinder head, the cam angle sensor being provided for a cam shaft at the upper face of the cylinder head; and fastening a mounting portion integral with the cam angle sensor to a member of the cylinder head by using a fixing member penetrating through the head cover.

2. The method according to claim 1, wherein the fixing member fastens simultaneously, to the member of the cylinder head, both the mounting portion of the cam angle sensor and a portion of the head cover through which the fixing member penetrates.

3. The method according to claim 1 or 2, wherein a collar made of a metal is disposed at the portion of the head cover through which the fixing member penetrates in such a manner that the collar abuts the mounting portion of the cam angle sensor and the member of the cylinder head.

4. A mounting device of a cam angle sensor in an internal combustion engine in which a head cover for covering a cam shaft at an upper face of a cylinder head is made of a synthetic resin,
wherein the cam angle sensor for the cam shaft is inserted in a through-hole perforated in the head cover, and a mounting portion integral with the cam angle sensor is fastened to a member of the cylinder head by a fixing member penetrating through the head cover.

5. The mounting device according to claim 4, wherein the fixing member fastens simultaneously, to the member of the cylinder head, both the mounting portion of the cam angle sensor and a portion of the head cover through which the fixing member penetrates.

6. The mounting device according to claim 4 or 5, wherein a collar made of a metal is disposed at the portion of the head cover through which the fixing member penetrates in such a manner that the collar abuts the mounting portion of the cam angle sensor and the member of the cylinder head.
